(19) United States
(12) Patent Application Publication
(10) Pub. No.: US 2021/0042873 A1
(43) Pub. Date: Feb. 11, 2021

(54) SYSTEMS AND METHODS FOR DISTRIBUTING A REQUEST

(71) Applicant: BEIJING DIDI INFINITY TECHNOLOGY AND DEVELOPMENT CO., LTD, Beijing (CN)

(72) Inventors: Junqin LI, Beijing (CN); Dingshui ZHANG, Beijing (CN)

(73) Assignee: BEIJING DIDI INFINITY TECHNOLOGY AND DEVELOPMENT CO., LTD., Beijing (CN)

(21) Appl. No.: 17/078,118

(22) Filed: Oct. 23, 2020

Related U.S. Application Data
(63) Continuation of application No. PCT/CN2019/083955, filed on Apr. 23, 2019.

(30) Foreign Application Priority Data
Apr. 23, 2018 (CN) 201810368883.X

(51) Int. Cl. G06Q 50/30; G06Q 30/02; G06Q 10/10; G06Q 40/00; G06N 20/00

(52) U.S. Cl. CPC G06Q 50/30; G06Q 30/0205; G06Q 10/1095; G06Q 10/06315; G06Q 30/0206; G06N 20/00; G06Q 40/12

(57) ABSTRACT

The present disclosure relates to systems and methods for distributing a request. The methods comprise obtaining a user request from a first device; determining a departure location and a departure time based on the user request; determining a target time based on the departure location and departure time; and distributing the user request to a second device based on the target time.

### CROSS-REFERENCE TO RELATED APPLICATIONS

This application is a continuation of International Patent Application No. PCT/CN2019/083955, filed on Apr. 23, 2019, which claims priority to Chinese Patent Application No. 201810368883.X, filed on Apr. 23, 2018, the contents of each of which are incorporated herein by reference in their entirety.

### TECHNICAL FIELD

The present disclosure generally relates to Internet application field, and more particularly, relates to systems and methods for allocating an online to offline service.

### BACKGROUND

With the development of Internet technology, online to offline services (e.g., taxi-hailing service) has entered a rapid developing era. For example, more and more people are willing to request an online to offline service from an online to offline platform using intelligent terminals. Taking the car-hailing service as an example, a passenger may send travel information including departure location, departure time and destination via a user interface to a taxi-hailing service platform to request for a vehicle. In the existing technology, the platform may generate an order and match a driver at a fixed time (e.g., half hour before the departure time, twenty minutes before the departure time, etc.) for the passenger, which may cause some problem, for example, the drive may wait for a long time for the passenger, and the order may be not matched successfully with a driver until the departure time. Therefore, it is desirable to provide systems and methods for distributing a request for services successfully and effectively.

### SUMMARY

According to an aspect of the present disclosure, a system for distributing a user's request is provided. The system may include at least one storage medium storing a set of instructions, and at least one processor in communication with the at least one storage medium. When executing the stored set of instructions, the at least one processor may cause the system to: obtain a user request from a first device; determine a departure location and a departure time based on the user request; determine a target time based on the departure location and departure time; and distribute the user request to a second device based on the target time.

In some embodiments, the at least one processor may be further configured to cause the system to: obtain a trained model, and determine the target time based on the trained model.

In some embodiments, the trained model may be generated according to a process for training a model. The process may include obtaining a preliminary model; obtaining a plurality of training samples; training the preliminary model to obtain the trained model using the obtained plurality of training samples.

In some embodiments, to determine target time based on the departure location and departure time, the at least one processor may be further configured to cause the system to: determine target information based on the departure location and departure time; determine one or more target features based on the target information; determine the target time based on the one or more target features.

In some embodiments, the at least one processor may be further configured to cause the system to: determine a target area based on the departure location; determine one or more reference time periods based on the departure time; determine reference information based on the one or more reference time periods and the target area; determine the target information based on the reference information associated with the one or more reference time periods and the target area.

In some embodiments, the one or more target features may include at least one of: an amount of the user request associated with the target area, an amount of the second device associated with the target area, a response rate associated with the user request in the target area, or a response time associated with the user request in the target area.

In some embodiments, the one or more reference time periods may include at least one of: a month-on-previous-month time period corresponding to the departure time, or a year-on-previous-year time period corresponding to the departure time.

In some embodiments, the trained model may include a logistic regression model, an adaptive boosting model or a gradient boosting decision tree (GBDT) model.

In some embodiments, the at least one processor may be further configured to cause the system to: obtain a historical order. The historical order may include a historical departure time, a historical departure location and a historical distribution time. The historical information may be determined based on the historical departure location and historical departure time. The at least one processor may be further configured to cause the system to determine one or more sample features based on the historical information; determine a training sample based on the one or more sample features and the historical distribution time.

According to another aspect of the present disclosure, a method implemented on a computing device for distributing a user's request may be provided. The computing device may include a memory and one or more processors. The method may include: obtaining a user request from a first device; determining a departure location and a departure time based on the user request; determining a target time based on the departure location and departure time; and distributing the user request to a second device based on the target time.

In some embodiments, the method may further include obtaining a trained model; and determining the target time based on the trained model.

In some embodiments, the trained model may be generated according to a process for training a model, and the method may further include: obtaining a preliminary model; obtaining a plurality of training samples; and training the preliminary model to obtain the trained model using the obtained plurality of training samples.

In some embodiments, the determining target time based on the departure location and departure time may further include: determining target information based on the departure location and departure time; determining one or more target features based on the target information; and determining the target time based on the one or more target features.

In some embodiments, the method may further include determining a target area based on the departure location; determining one or more reference time periods based on the departure time; determining reference information based on the one or more reference time periods and the target area; and determining the target information based on the reference information associated with the one or more reference time periods and the target area.

In some embodiments, the one or more target features may include at least one of: an amount of the user request associated with the target area, an amount of the second device associated with the target area, a response rate associated with the user request in the target area, or a response time associated with the user request in the target area.

In some embodiments, the one or more reference time periods may include at least one of: a month-on-previous-month time period corresponding to the departure time, or a year-on-previous-year time period corresponding to the departure time.

In some embodiments, the trained model may include a logistic regression model, an adaptive boosting model or a gradient boosting decision tree (GBDT) model.

In some embodiments, the method may further include: obtaining a historical order, wherein the historical order include a historical departure time, a historical departure location and a historical distribution time; determining historical information based on the historical departure location and historical departure time; determining one or more sample features based on the historical information; and determining a training sample based on the one or more sample features and the historical distribution time.

According to still another aspect of the present disclosure, a non-transitory computer readable medium comprising executable instructions may be provided. When executed by at least one processor, the executable instructions may cause the at least one processor to effectuate a method comprising: obtaining a user request from a first device; determining a departure location and a departure time based on the user request; determining a target time based on the departure location and departure time; and distribute the user request to a second device based on the target time.

In some embodiments, the method may further include: determining target information based on the departure location and departure time; determining one or more target features based on the target information; and determining the target time based on the one or more target features.

According to still another aspect of the present disclosure, a method for distributing an appointment request may be provided. The method may include: determining a departure location and a departure time associated with the appointment request needed to be distributed; determining a target time of the appointment request based on the departure location and the departure time; and distributing the appointment request in response to the arrival of the target time.

In some embodiments, the determining the target time of the appointment request based on the departure location and the departure time may include: obtaining a pre-trained model; determining the target time using the trained model based on the departure location and the departure time.

In some embodiments, the determining the target time using the trained model based on the departure location and the departure time may include: obtaining target information based on the departure location and the departure time; extracting target features from the target information; inputting the target features into the pre-trained model to obtain the target time from output results of the trained model.

In some embodiments, the obtaining target information based on the departure location and the departure time may include: determining a service region associated with the department location; determining a month-on-previous-month time period, a year-on-previous-year time period, and a real-time time period corresponding to the departure time; and obtaining, within the month-on-month time period, the year-on-previous-year time period, and the real-time time period, reference information associated with the service region to obtain target feature information.

In some embodiments, the target feature information may include: month-on-previous-month feature information, year-on-previous-year feature information, and real time feature information.

In some embodiments, the year-on-previous-year feature information may include one or more of: feature information associated with a total amount of requests in the service region during the year-on-previous-year period; feature information associated with a transport capacity in the service region during the year-on-previous-year period; feature information associated with a response rate in the service region during the year-on-previous-year time period; feature information associated with a response time in the service region during the year-on-previous-year time period; feature information associated with dynamic fee adjustment in the service region during the year-on-previous-yeartime period. The month-on-previous-month feature information may include one or more of: feature information associated with a total amount of requests in the service region during the month-on-previous-month time period; feature information associated with a transport capacity in the service region during the month-on-previous-month time period; feature information associated with a response rate in the service region during the month-on-previous-month time period; feature information associated with a response time in the service region during the month-on-previous-month time period; feature information associated with dynamic fee adjustment in the service region during the month-on-previous-month time period. The real-time feature information may include one or more of: feature information associated with a total amount of requests in the service region during the real-time time period; feature information associated with a transport capacity in the service region during the real-time preset time period; feature information associated with a response rate in the service region during the real-time time period; feature information associated with response time in the service region during the real-time preset time period; feature information associated with dynamic fee adjustment in the service region during the real-time time period.

According to still another aspect of the present disclosure, an apparatus for distributing an appointment request may be provided. The apparatus may include: a first determining unit configured to determine a departure location and a departure time based on the appointment request to be distributed; a second determining unit configured to determine, based on the departure location and the departure time, a target time of the appointment request; a distributing unit configured to distribute the appointment request in response to the arrival of the target time.

In some embodiments, the second determining unit may include: an acquisition sub-unit configured to obtain a pre-trained model; a determination sub-unit configured to determine the target time using the pre-trained model based on the departure location and the departure time.

In some embodiments, the determination sub-unit may include: an information acquisition sub-unit configured to obtain target information based on the departure location and the departure time; an extracting sub-unit configured to extract target features from the target information; an input sub-unit configured to input the target features into the pre-trained model to obtain the target time from output results of the trained model.

In some embodiments, the information acquisition sub-unit may be configured to: determine a service region associated with the department location; determine a month-on-previous-month time period, a year-on-previous-year time period, and a real-time time period corresponding to the departure time; and obtain reference information associated with the service region to obtain the target information within the month-on-previous-month time period, the year-on-previous-year time period, and the real-time time period.

In some embodiments, the target feature information may include: month-on-previous-month feature information, year-on-previous-year feature information, and real time feature information.

In some embodiments, the year-on-previous-year feature information may include one or more of: feature information associated with total amount of requests in the service region during the year-on-previous-year time period; feature information associated with transport capacity in the service region during the year-on-previous-year time period; feature information associated with response rate in the service region during the year-on-previous-year time period; feature information associated with response time in the service region during the year-on-previous-year period; feature information associated with dynamic fee adjustment in the service region during the year-on-previous-year time period. The month-on-previous-month feature information may include one or more of: feature information associated with total amount of requests in the service region during the month-on-previous-month time period; feature information associated with transport capacity in the service region during the month-on-previous-month time period; feature information associated with response rate in the service region during the month-on-previous-month time period; feature information associated with response time in the service region during the month-on-previous-month; feature information associated with dynamic fee adjustment in the service region during the month-on-previous-month time period. The real-time feature information may include one or more of: feature information associated with total amount of requests in the service region during the real-time time period; feature information associated with transport capacity in the service region during the real-time preset time period; feature information associated with response rate in the service region during the real-time time period; feature information associated with response time in the service region during the real-time preset time period; feature information associated with dynamic fee adjustment in the service region during the real-time time period.

According to still another aspect of the present disclosure, a computer readable storage medium storing at least one set of computer instructions may be provided. When executed by at least one of processors of a computing device, the at least one set of computer instructions may cause the computing device to implement the mentioned method for distributing the appointment request.

According to still another aspect of the present disclosure, an electronic device comprising a memory, a processor, and at least one set of computer instructions stored on the memory and operated on the processor may be provided. When executed by the processor, the at least one set of computer instructions cause the processor to implement the mentioned method for distributing the appointment request.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating an exemplary system architecture according to some embodiments of the present disclosure;

FIG. 3 is a schematic diagram illustrating exemplary hardware and/or software components of an exemplary service requestor terminal according to some embodiments of the present disclosure;

FIG. 4 is a schematic diagram illustrating exemplary hardware and software components of a computing device according to some embodiments of the present disclosure;

FIG. 5 is a schematic diagram illustrating exemplary hardware and/or software components of an exemplary mobile device on which a terminal device may be implemented according to some embodiments of the present disclosure;

FIG. 6 is a block diagram illustrating a distribute apparatus of an appointment request according to an embodiment of the present disclosure;

FIG. 7 is a block diagram illustrating an exemplary processing engine according to some embodiments of the present disclosure;

FIG. 8 is a flowchart illustrating a method for distributing an appointment request according to some embodiments of the present disclosure;

FIG. 9 is a flowchart illustrating another method for distributing an appointment request according to some embodiments of the present disclosure;

FIG. 10 is a flowchart illustrating another method for distributing an appointment request according to some embodiments of the present disclosure;

FIG. 11 is a flowchart illustrating a process for distributing a user request according to some embodiments of the present disclosure;

FIG. 12 is a flowchart illustrating a process for determining a target time according to some embodiments of the present disclosure;

FIG. 13 is a flowchart illustrating a process for determining a target information according to some embodiments of the present disclosure; and

FIG. 14 is a flowchart illustrating a process for determining a target information based on a trained model according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Some embodiments of the present disclosure are directed to an on-line service prediction function applicable in, e.g., on-demand services, which is a newly emerged service or demand rooted only in the post-Internet era. It provides the technical solutions to customers that could rise only in the post-Internet era. In the pre-Internet era, it is impossible to predict types of services requested by users. Therefore, the present solution is deeply rooted in and aimed to solve a problem only occurred in the post-Internet era.

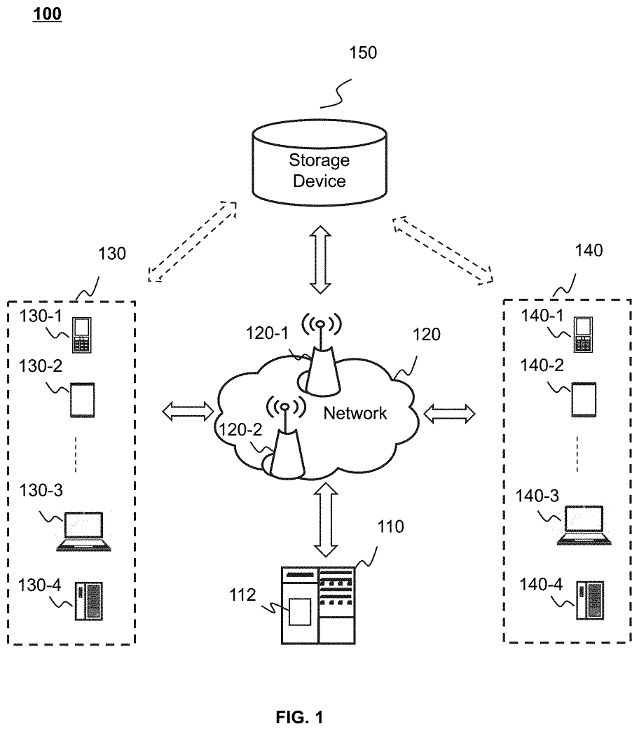

FIG. 1 is a schematic diagram illustrating an exemplary online to offline service system 100 according to some embodiments of the present disclosure. The online to offline system 100 may be a transportation service platform for providing transportation related services. The online to offline service system 100 may include a server 110, a network 120, a service requestor terminal 130, a service provider terminal 140, and a storage device 150. In some embodiments, the online to offline service system 100 may further include a positioning device 160 (not shown in FIG. 1).

The online to offline service system 100 may be applicable in a plurality of services. Exemplary services may include a travel plan service, a navigation service, an on-demand service (e.g., a taxi hailing service, a chauffeur service, an express car service, a carpool service, a bus service, or a driver hire service), or the like, or a combination thereof. In some embodiments, the online to offline service may be an online service, for example, booking a meal service, an express service, booking a meal, shopping, booking a bus, booking a train, booking a flight, booking a table at a restaurant, booking a room at a hotel, booking a register at a hospital, booking a ticket (e.g., a movie ticket, a concert ticket), or the like, or any combination thereof.

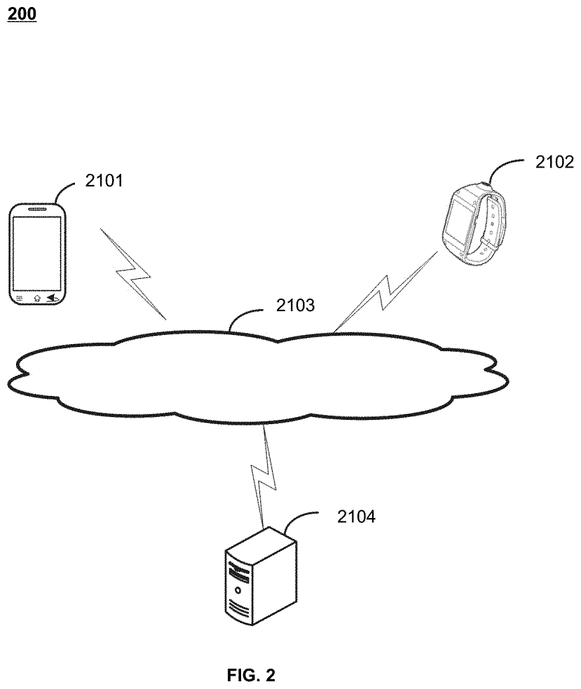

The server 110 may process data and/or information from one or more components of the online to offline service system 100 or an external data source (e.g., a cloud data center). The server 110 may communicate with the service requestor terminal 130 and/or the service provider terminal 140 to provide various functionality of online services. In some embodiments, the server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access information and/or data stored in the service requestor terminal 130, the service provider terminal 140, and/or the storage device 150 via the network 120. As another example, the storage device 150 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented in a computing apparatus 300 having one or more components illustrated in FIG. 2 in the present disclosure.

In some embodiments, the server 110 may include one or more processing devices 112. The processing device 112 may process information and/or data related to one or more functions described in the present disclosure. In some embodiments, the processing device 112 may process information and/or data to perform main functions of the online to offline service system 100. For example, the processing device 112 may receive information and/or data from the service requestor terminal 130, the service provider terminal 140, the storage device 150, or an external device, or any combination thereof. As another example, the processing device 112 may obtain a user request from a terminal (e.g., the service requestor terminal 130). As still another example, the processing device 112 may determine a time for distributing the user request. As further example, the processing device 112 may distribute the user request to another terminal (e.g., the service provider terminal 140). In some embodiments, the processing device 112 may perform other functions related to the method and system described in the present disclosure.

In some embodiments, the processing device 112 may include one or more processing units (e.g., single-core processing device(s) or multi-core processing device(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the online to offline service system 100 (e.g., the server 110, the service requestor terminal 130, the service provider terminal 140, the storage device 150) may send information and/or data to other component(s) in the online to offline service system 100 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline service system 100 may be connected to the network 120 to exchange data and/or information.

The service requestor terminal 130 and/or the service provider terminal 140 may communicate with the server 110 via the network 120. In some embodiments, a passenger or a customer may be an owner of the service requestor terminal 130. In some embodiments, the owner of the service requestor terminal 130 may be someone other than the passenger or the customer. For example, an owner A of the service requestor terminal 130 may use the service requestor terminal 130 to send a service request for a passenger B, and/or receive a service confirmation and/or information or instructions from the server 110. In some embodiments, a driver may be a user of the service provider terminal 140. In some embodiments, the user of the service provider terminal 140 may be someone other than the driver. For example, a user C of the service provider terminal 140 may use the service provider terminal 140 to receive a service request for a driver D, and/or information or instructions from the server 110. In some embodiments, a driver may be assigned to use one of the service provider terminals 140 for at least a certain period of time. For example, when a driver is available to provide an on-demand service, he/she may be assigned to use a driver terminal that receives an earliest request and a vehicle that is recommended to perform the type of on-demand service. In some embodiments, “passenger”, “customer”, “user” and “service requestor terminal” may be used interchangeably. In some embodiments, the service provider terminal may associate with one or more service providers (e.g., a night-shift service provider, or a day-shift service provider).

In some embodiments, the service requestor terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the service requestor terminal 130 may include a signal transmitter and a signal receiver configured to communicate with the positioning device for locating the position of the passenger and/or the service requestor terminal 130.

The driver may receive a service request via the service provider terminal 140. The service provider terminal 140 may include a plurality of service provider terminals 140-1, 140-2, . . . , 140-n. In some embodiments, the service provider terminal 140 may be similar to, or same as the service requestor terminal 130. In some embodiments, the service provider terminal 140 may be customized to implement online services based on travel related information obtained from the processing devices 112.

The storage device 150 may store data and/or instructions. The data may include geographic location information, time information, driver information, user information, external environment, or the like. Merely for illustration purposes, data related to geographic location information may include a service location (i.e., a departure location), a destination, a location of a driver, etc. Data related to time information may include a service time (i.e., a departure time), an order distributing time, an order-complete time, etc. Data related to driver information may include a driver identification (ID), a user profile of the driver, an account of the driver, etc. Data related to user information may include a user ID, a user profile of the user, etc. In some embodiments, the storage device 150 may store data obtained from the service requestor terminal 130 and/or the service provider terminal 140. For example, the storage device 150 may store logs associated with the service requestor terminal 130.

In some embodiments, the storage device 150 may store data and/or instructions that the processing device 112 may execute to predict service types of customers as described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the online-to-offline service system 100 (e.g., the server 110, the service requestor terminal 130, the service provider terminal 140, etc.). One or more components in the online to offline service system 100 may access the data or instructions stored in the storage device 150 via the network 120. In some embodiments, the storage device 150 may be directly connected to or communicate with one or more components in the online to offline service system 100 (e.g., the server 110, the service requestor terminal 130, the service provider terminal 140, etc.).

It should be noted that the online to offline service system 100 is merely provided for the purposes of illustration, and is not intended to limit the scope of the present disclosure. For persons having ordinary skills in the art, multiple variations or modifications may be made under the teachings of the present disclosure. However, those variations and modifications do not depart from the scope of the present disclosure. For example, the online to offline service system 100 may further include a database operated by the storage device 140, an information source, or the like. As another example, the online to offline service system s 100 may be implemented on other devices to realize similar or different functions.

FIG. 2 is a schematic diagram illustrating an exemplary system architecture according to some embodiments of the present disclosure.

As shown in FIG. 2, the system architecture 200 may include one or more terminal devices such as terminal device 2101, terminal device 2102, network 2103, and server 2104. It should be understood that the number or type of terminal device, network and server in FIG. 2 is merely illustrative. According to different implementation needs, there may be any number or type of terminal device, network, and server.

The network 2103 may be used to provide a medium for communication or connection between the terminal devices and the server. The network 2103 may include various types of connections, such as wired and/or wireless communication link, fiber optic cables, or the like, or any combination thereof.

The terminal devices 2101, 2102 may interact with the server through the network 2103 to receive or send requests or information. The terminal devices 101, 102 may include various electronic devices including but not limited to a smartphone, a tablet computer, a smart wear device, a personal digital assistant, or the like, or any combination thereof.

The server 2104 may include a server that may provide various services. The server may store, analyze the received data, or send control commands or requests to the terminal devices or other servers. The server may provide services in response to the user's service request. It should be understood that one server may provide one or more services, and one type of service may also be provided by a plurality of servers.

Based on the system architecture shown in FIG. 1, in some embodiments of the present disclosure, the terminal devices may send an appointment request needed to be distributed to the server through the network 120. The server 110 may determine the target time of the appointment request for distributing the request according to the departure location and the departure time associated with the appointment request and distribute the appointment request when the target time arrives.

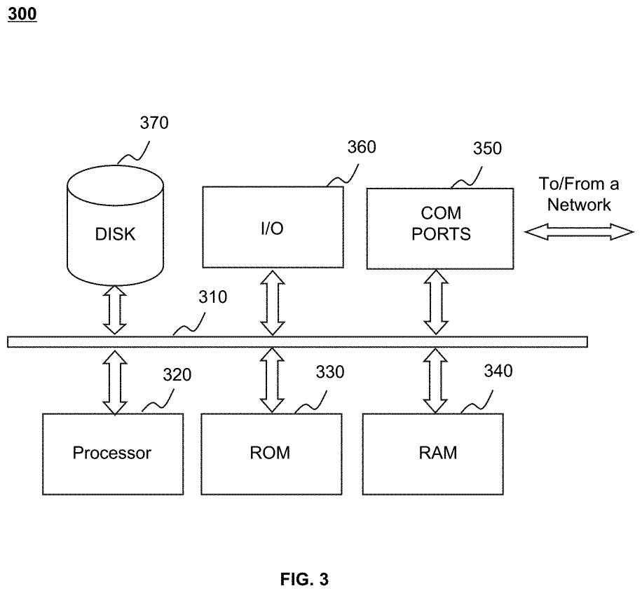

FIG. 3 is a schematic diagram illustrating exemplary hardware and software components of a computing device 300 on which the server 110, the service requester terminal 130, and/or the service provider terminal 140 may be implemented according to some embodiments of the present disclosure. For example, the processing device 112 may be implemented on the computing device 200 and configured to perform functions of the processing device 112 disclosed in this disclosure.

The computing device 300 may be a special purpose computer in some embodiments. The computing device 200 may be used to implement an online to offline service system for the present disclosure. The computing device 200 may implement any component of the online to offline service as described herein. In FIGS. 1-2, only one such computer device is shown purely for convenience purposes. One of ordinary skill in the art would understand that the computer functions relating to the online-to-offline service as described herein may be implemented in a distributed fashion on a number of similar platforms, to distribute the processing load.

The computing device 300, for example, may include COMM ports 350 connected to and from a network (e.g., the network 120) connected thereto to facilitate data communications. The computing device 300 may also include a processor 320, in the form of one or more processors, for executing program instructions. The exemplary computer platform may include an internal communication bus 310, program storage and data storage of different forms, for example, a disk 370, and a read only memory (ROM) 330, or a random access memory (RAM) 340. The exemplary computer platform may also include program instructions stored in the ROM 330, the RAM 340, and/or other type of non-transitory storage medium to be executed by the processor 320. The methods and/or processes of the present disclosure may be implemented as the program instructions. The computing device 300 also includes an I/O 360, supporting input/output between the computer and other components therein.

The computing device 300 may also receive programming and data via network communications.

Merely for illustration, only one processor is described in the computing device 300. However, it should be noted that the computing device 300 in the present disclosure may also include multiple processors, thus operations and/or method steps that are performed by one processor as described in the present disclosure may also be jointly or separately performed by the multiple processors. For example, the processor of the computing device 200 executes both step A and step B. As in another example, step A and step B may also be performed by two different processors jointly or separately in the computing device 300 (e.g., the first processor executes step A, and the second processor executes step B; or the first and second processors jointly execute steps A and B).

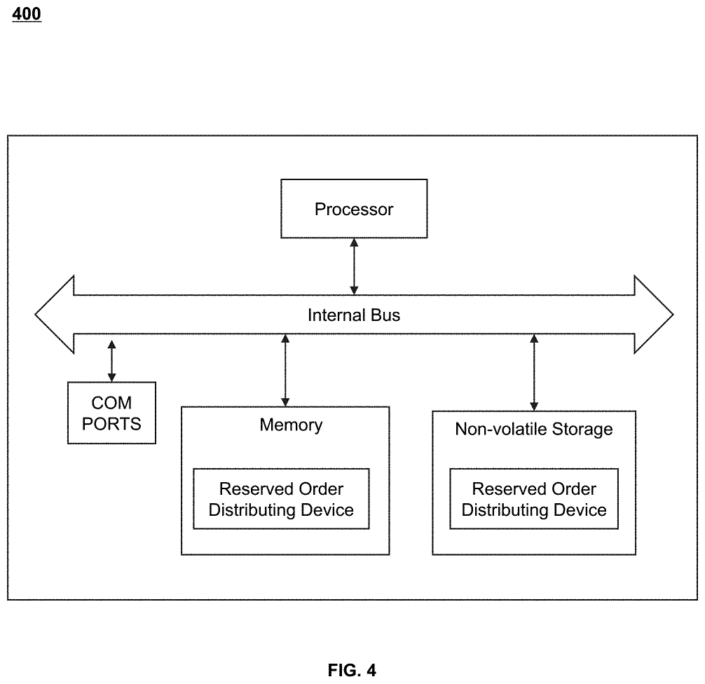

FIG. 4 is a schematic diagram illustrating exemplary hardware and software components of a computing device 400 according to some embodiments of the present disclosure.

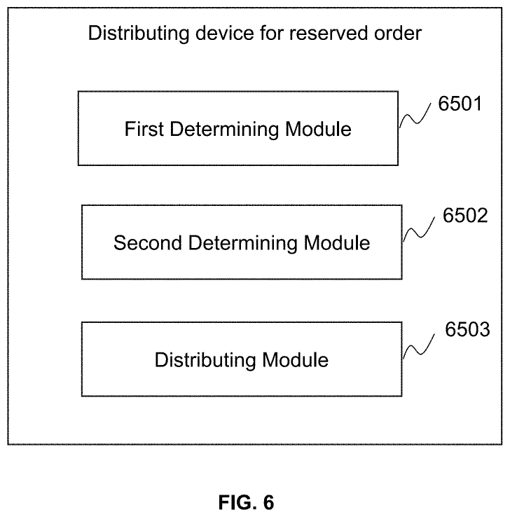

In response to a method for distributing the above mentioned appointment request, an exemplary device may be provided in FIG. 4 according to some embodiments of the present disclosure. With reference to FIG. 6, hardware of the electronic device may include a processor, an internal bus, COM ports, a memory, and a non-volatile storage, and other hardware. The processor may read the corresponding computer program from the non-volatile memory into the memory, run the computer program, and form a distributing device for distributing request on a logical level. Of course, except for software implementation, the present disclosure may not exclude other implementations, such as logic devices or a combination of hardware and software, in other words, an execution subject of the following process is not limited to each logic unit, but may also include hardware or a logic device.

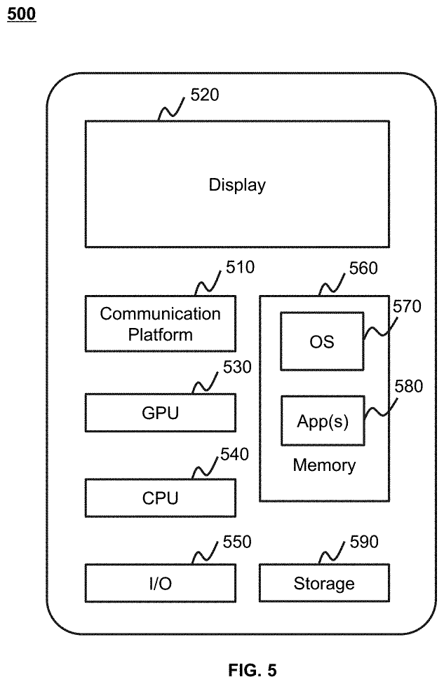

FIG. 5 is a schematic diagram illustrating exemplary hardware and/or software components of an exemplary mobile device on which a terminal device may be implemented according to some embodiments of the present disclosure. As illustrated in FIG. 5, the mobile device 500 may include a communication platform 510, a display 520, a graphic processing unit (GPU) 530, a central processing unit (CPU) 540, an I/O 550, a memory 560, and storage 590. In some embodiments, any other suitable component, including but not limited to a system bus or a controller (not shown), may also be included in the mobile device 500. In some embodiments, a mobile operating system 570 (e.g., iOS™, Android™, Windows Phone™) and one or more applications 580 may be loaded into the memory 560 from the storage 590 in order to be executed by the CPU 540. The applications 580 may include a browser or any other suitable mobile apps for receiving and rendering information relating to positioning or other information from the processing device 112. User interactions with the information stream may be achieved via the I/O 550 and provided to the processing device 112 and/or other components of the online to offline service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

FIG. 6 is a block diagram illustrating a distribute apparatus of an appointment request according to an embodiment of the present disclosure. The apparatus may include a first determining unit 6501, a second determining unit 6502, and a distributing unit 6503.

Wherein, the first determining module 6501 may be configured to determine a departure location and a departure time associated with an appointment service request needed to be distributed.

In some embodiments, the service may include an online to offline vehicle service. Taking the online to offline vehicle service as an example, the online to offline vehicle service may include a plurality of different types. For example, an express service, a premier car service, a shuttle service, a testing drive service and car hailing service. Wherein, some types of vehicle services may support an advance reservation, which may allow service requester terminal to issue request in advance. Therefore, the appointment request needed to be distributed may be an appointment request issued in advance by the service requester terminal for the online to offline vehicle service.

In some embodiments, the departure location and the departure time associated with the appointment request may be obtained according to the request content of the appointment request needed to be distributed.

The second determining module 6502 may be configured to determine a target time of the appointment request according to the departure location and the departure time.

In some embodiments, the target time of the appointment request may be determined according to the departure location and the departure time associated with the appointment request needed to be distributed. The target time may be a reasonable time for distributing the appointment request.

In some embodiments, statistical analysis may be performed on the historical data to obtain a distribution rule of the transport capacity in time and space. Combined with the departure location and the departure time, the reasonable time to distribute the appointment request may be predicted as the target time according to the distribution rule.

In some embodiments, the machine learning method may also be used to determine the target time of distributing the appointment request. Specifically, a pre-trained model may be obtained, and according to the departure location and the departure time associated with the appointment request, the trained model may be used to predict the optimal time as the target time of the appointment request.

It should be understood that the target time of the appointment request may be be determined based on the departure location and the departure time by other means, and the disclosure may not limit it in this aspect.

The distributing module 6503 may be configured to distribute the appointment request in response to the arrival of the target time.

In some embodiments, when the target time arrives, the appointment request may be distributed. For example, the processing device 112 may broadcast the appointment request at the target time, or match an appropriate service provider for the appointment request at the target time. It should be understood that the present disclosure may not limit the manners to distribute the appointment request.

The distribution apparatus for the appointment request provided by some embodiments of the present disclosure may determine the target time of the distribute appointment request based on the departure location and the departure time, and distribute the appointment request in response to the arrival of the target time. Therefore, the appointment request may be distributed at a reasonable time, which may avoid the problem that the service provider may wait too long after accepting the order, or the request may be not successfully matched with a service provider until the order departure time, and improve service efficiency and utilization of service resources.

In some embodiments, the second determining module 6502 may include an acquisition sub-unit and a determination sub-unit (not shown).

Wherein, the acquisition sub-unit may be configured to obtain a pre-trained trained model.

The determination sub-unit may be configured to determine the target time using the trained model based on the departure location and the departure time.

In some embodiments, the trained model may be trained as followings: Firstly, obtaining the sample information in a sample data set. The sample information may include a month-on-previous-month reference information associated with the departure location of the request sample, a year-on-year reference information, and a real-time reference information.

Then, the sample feature information may be obtained based on the sample information, and the distribution time information of the sample request may be obtained based on the sample information. The sample feature information may include a sample month-on-previous-month feature information, a sample year-on-previous-year feature information, and a sample real-time feature information. The sample month-on-previous-month feature information may include but is not limited to feature information about total amount of orders, feature information about the transport capacity, feature information about response rate, t feature information about response time, feature information about dynamic fee adjustment, and the like, in a server region associated with the departure location of the sample request in a month-on-previous-month time period.

The sample year-on-previous-year feature information may include but is not limited to feature information about total amount of orders, feature information about the transport capacity, feature information about response rate, t feature information about response time, feature information about dynamic fee adjustment, and the like, in a server region associated with the departure location of the sample request in a year-on-previous-year time period.

The sample real-time feature information may include but is not limited to feature information about total amount of orders, feature information about the transport capacity, feature information about response rate, feature information about response time, feature information about dynamic fee adjustment, and the like, in a server region associated with the departure location of the sample request in a real-time time period.

Finally, the model may be trained using the sample feature information and the distribution time of the sample request.

In some embodiments, the trained model may include at least one of: a logistic regression model, a decision tree model and/or a neural network model.

In some embodiments, the target time may be determined by using the trained model according to the departure location and the departure time as followings: Firstly, the target information may be obtained according to the departure location and the departure time. Then, the target features may be extracted from the target information, and the target features may be inputted into the trained model, and the target time may be obtained from the output of the trained model.

In some embodiments, the determination sub-unit may include an information acquisition sub-unit and an extraction sub-unit (not shown).

Wherein, the information acquisition sub-unit may be configured to obtain target information based on the departure location and the departure time.

In some embodiments, specifically, the server region associated with the departure location may be determined firstly. The server region associated with the department location may be a region of a preset area around the department location. For example, the service may be a circle region whose preset distance is a radius and the departure location may be the center of the circle. It should be understood that the present disclosure may not limit the server region associated with the department location.

Then, the month-on-previous-month time period, the year-on-previous-year time period, and the real time period associated with the departure time may be determined. And reference information associated with the server region in a month-on-previous-month time period, the year-on-previous-year time period, and the real-time time period may be obtained, and based on the reference information, the target information may be obtained. The reference information associated with the server region may include, but is not limited to, a total amount of orders information, a transport capacity information, a response rate information, a response time information, a dynamic fee adjustment information, and the like, or any combination thereof.

The extraction sub-unit may be configured to extract target features from the target information.

An input sub-unit may be configured to input the target features into the trained model to obtain the target time from output results of the trained model.

In some embodiments, the information acquisition sub-unit may be configured to: determine the server region associated with the departure location, determine a month-on-previous-month time period, a year-on-previous-year time period, and a real time period associated with the departure time, obtain the reference information associated with the server region in a month-on-previous-month time period, a year-on-previous-year time period, and a real time period to obtain target information.

In some embodiments, the target features may include: month-on-previous-month feature information, year-on-previous-year feature information, and real time feature information.

In some embodiments, the month-on-previous-month feature information may include one or more of the following: feature information about total amount of requests in the server region during the month-on-previous-month time period; feature information about transport capacity in the server region during the month-on-previous-month time period; feature information about response rate feature information in the server region during a month-on-previous-month time period; feature information about response time in the server region during the month-on-previous-month time period; feature information about dynamic fee adjustment in the server region during the month-on-previous-month time period.

The feature information during the year-on-previous-year time period may include one or more of the followings: the feature information about total amount of requests in the server region during the year-on-previous-year time period; feature information about the transport capacity in the server region during the year-on-previous-year time period; feature information about the response rate in the server region during the year-on-previous-year time period; feature information about the response time in the server region during the year-on-previous-year time period; feature information about the dynamic fee adjustment in the server region during the year-on-previous-year time period.

The real-time feature information may include one or more of the followings: the feature information about total amount of requests in the server region during real-time time period; feature information about the transport capacity in the server region during the real-time time period; feature information about the response rate in the server region during the real-time time period; feature information about the response time in the server region during the real-time time period; feature information about the dynamic fee adjustment in the server region during the real-time time period.

The embodiments of the apparatus may be substantially associated with the embodiments of the method, and more detailed description may refer to the description in embodiments of the method. The embodiments of the apparatus described above are merely illustrative, an element described as a separated mean may be or may not be physically separated, and element shown as an element may or may not be a physical element, which means they may be located in one place, or distributed to multiple network elements. Some or all of the modules may be selected according to actual needs to achieve the objectives of the present disclosure. Those ordinary skilled in the art may understand and carry out the embodiments without paying creative work.

It should be understood that the apparatus may be pre-set in the server, or may be loaded into the server by downloading, or the like. The corresponding unit(s) in the apparatus may cooperate with the unit(s) in the server to implement the distribution of the appointment request.

The embodiments in the present disclosure may take the form of a computer program product implemented on one or more storage media (including, but not limited to, a disk storage, a CD-ROM, an optical memory) containing program code.

Correspondingly, the embodiments in the present disclosure may provide a computer readable storage medium, where the computer program may be stored, and the computer program may be used to execute the distributing method of the appointment request provided by any of the embodiments in FIG. 2 to FIG. 4.

Wherein, the computer readable storage medium may be a computer readable storage medium included in the apparatus described in the embodiments. It may also be a computer readable storage medium that exists alone and is not assembled into a terminal or server. The computer readable storage medium may store one or more programs that are used by one or more processors to execute the distribute method of the appointment request in the present disclosure.

The computer readable storage medium may include permanent and non-permanent, removable and non-removable medium, and may use any method or technology to realize information storage. The information may be a computer readable instruction, a data structure, and a module of a program or other data. Examples of the storage medium may include but not limited to: a Phase-Change Random Access Memory (PRAM), a Static Random Access Memory (SRAM), a Dynamic Random Access Memory (DRAM), other types of Random Access Memory (RAM), a Read Only Memory (ROM), an Electrically Erasable Programmable Read-Only Memory (EEPROM), a flash memory or other memory technology, a Compact Disc-Read Only Memory (CD-ROM), a Digital Versatile Disc (DVD) or other optical storage, a cassette magnetic tape, a magnetic tape, a magnetic disk storage or other magnetic storage devices or any other non-transmission media. The examples of the storage medium may be used to store information that can be accessed by the computing device.

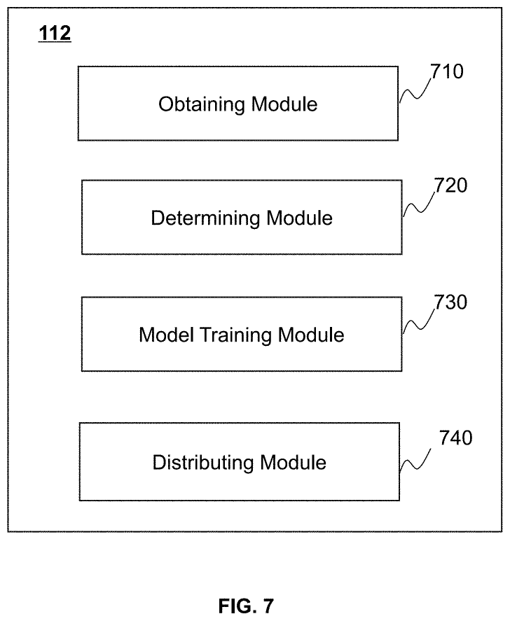

FIG. 7 is a block diagram illustrating an exemplary processor according to some embodiments of the present disclosure. The processing engine 112 may include an obtaining module 710, a determining module 720, a model training module 730, and a distributing module 740.

The obtaining module 710 may obtain a user request from a first device.

In some embodiments, the user request (also refered as current user reques) may be used to request an online to offline service for the user. The online to offline service may include a a delivery service, a taxi-hailing service, a test drive service, a designated driving service, or the like, or any combination thereof. In some embodiments, the user request may include a real-time request, an appointment request, or a pending request, or the like. In some embodiments, the user request may be generated by the processing device 112 based on request information from the first device. The first device may be used to communicate and/or connect the user with and/or to the online to offline system 100 via the network 120 or network 2103. For example, the user may input the travel information into the first device through the I/O 350.

Taking the taxi-hailing service as an example, the request information may include information about the request, information about the user, and other information. The information about the request may include but not limited to a time point when the request may be sent, an request identification, a departure location, a destination, a departure time, an arrival time, an acceptable waiting time, the number of passengers, whether agrees to share a vehicle with other passengers, a selected vehicle model, carrying luggage or not, a mileage, a price, an increasing price by consumer, a price adjustment by the service provider, a price adjustment by the system, a status of using red packet, a payment mode (e.g., a cash payment, a credit card payment, an online payment, a remittance payment), request completion status, request selection status by the service provider, request sending status by the consumer, or the like, or any combination thereof. The information about the user may include but not limited to name, nickname, gender, nationality, age, contact information (phone number, microphone number, social network account (e.g., WeChat number, QQ number, LinkedIn account, etc.), or the like, or other way through which a person can be contacted), occupation, grade evaluation, driving experience, vehicle age, vehicle type, vehicle status, vehicle license number, driving license number, authentication status, user preference, extra service (e.g., extra service including a size of the vehicle trunk, a panoramic sunroof), or the like, or any combination thereof. The other information may include information that is not controlled by the consumer or the service provider or temporal/emergent information. For example, the other information may include but not limited to weather status, environment, road (e.g., blocked road because of safety or road works), traffic, or the like, or any combination thereof.

In some embodiments, the first device may include one or more terminals (e.g., the service requestor terminal 130). In some embodiments, the first device may send the user request to the processing device 112 via a data exchange port that is communicatively connected to the network 120. The processing device 112 may obtian the user request via the data exchange port.

The determining module 720 may determine departure location and departure time based on the user request.

In some embodiments, the processing device 112 may process the travel information of the user and determine the departure location and departure time based on the user's travel information inputted by the user. In some embodiments, the processing engine 112 may determine current location information of the user via a positioning device on the first device (e.g., the service requester terminal 130) as the departure location. In some embodiments, the processing device 112 may determine the time that the first device sent the user request as the departure time. For example, the departure location may be obtained by one or more positioning chips installed in the first device and/or a navigation system (not shown in figures). As another example, the departure location may be determined by the processing engine 112 based on user preference, historical requests and/or information (e.g., historical orders), etc. As a further example, the processing engine 112 may recommend a departure location to the user based on historical requests launched by the user.

The determining module 1103 may determine target time based on the departure location and departure time.

In some embodiments, the target time may be a preference time for the online to the offline system 100 to distribute the user request to another device (e.g., a second device). For example, the target time may be a time point at which the distributed request may have a higher successful turnover rate. As another example, the target time may be a time period during which the cost of the request may be lower than during other time periods. For example, the target time may be a time period from 20 minutes to 90 minutes before the starting time of the service. The processor 320 may distribute the appointment invitation to a plurality of service provider terminals before 20 minutes to 90 minutes of the departure time.

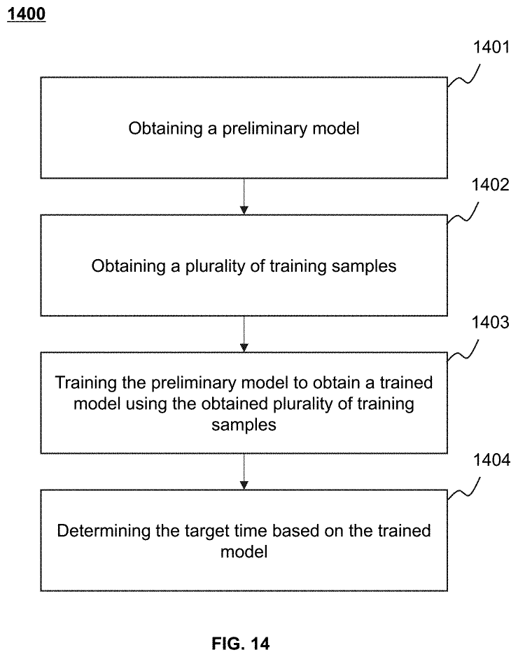

In some embodiments, the processing device 112 may determine the target time based on a plurality of historical requests launched by one or more users. The historical request may include but not limited to request information The plurality of historical requests may include the requests have a time interval from the current time, for example, 5 minutes, one hour, one day, one month, one year, etc. The time interval may be preset by the online to offline system 100 or may be adjusted according to different conditions. The plurality of historical requests may be stored in a storage device, e.g., the storage device 150. In some embodiments, the processing device 112 may communicate with or connected to the storage device to obtain all of or part of the historical requests via the network 120, e.g., the departure location, the departure time, the distributing time, an equation between the departure location, departure time and the distributing time, or the like, or any combination thereof. For example, the processing device 112 may determine a distributing time of a historical request who may have same or similar departure location and departure time as or with the user request from the first device as the target time of the user request. As another example, the processing device 112 may determine the target time of the user request using a fitting method and/or an interpolation method based on the equation between the departure location, departure time and the distributing time. As still another example, the processing device 112 may determine the target time of the user request using a prediction model. The prediction model may include but is not limited to a weighted arithmetic average model, a trend average prediction model, an exponential smoothing model, an average development speed model, a unitary linear regression model, and a high and low point model. As a further example, the processing device 112 may determine the target time of the user request using a model training method. The model may include but is not limited to a regression algorithm model, an instance-based model, a normalized model, a decision tree model, a Bayesian model, a clustering algorithm model, an association rule model, a neural network model, a deep learning model, a reduced dimensional algorithm model, etc. More detailed description for model training method may be found elsewhere in the present disclosure, for example, FIG. 14 and the description thereof.

The distributing module 740 may distribute the user request to a second device based on the target time.

In some embodiments, the processing device 112 may transmit information (e.g., the request information) to one or more service provider terminals 140, one or more service request terminals 130, one or more third parties, or the like, or any combination thereof.

In some embodiments, the second device may include one or more terminals (e.g., the service provider terminal 140). In some embodiments, the first device may send/receive information or signal to/from the processing device 112 via a data exchange port that is communicatively connected to the network 120. The processing device 112 may distribute the user request to the second device via the data exchange port. In some embodiments, the processing device 112 may distribute the user request to one or more service provider terminals 140. The one or more service provider terminals 140 may grab the request. In some embodiments, the processing engine 112 may distribute the request to one service provider terminal of the one or more service provider terminals.

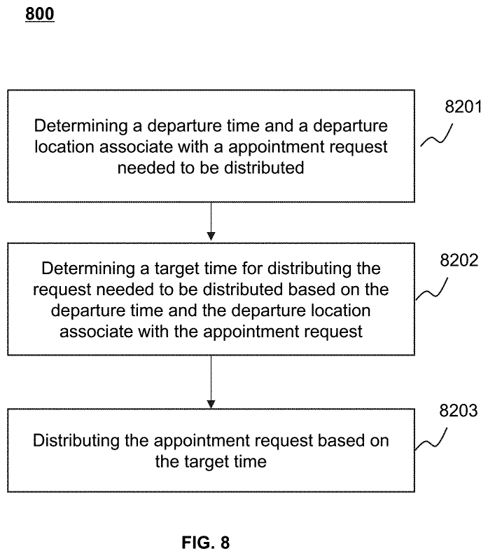

FIG. 8 is a flowchart illustrating a method for distributing an appointment request according to some embodiments of the present disclosure. The method may be executed by a server. The method may include following operations:

In 8201, the server 2104 or 110 may determine the departure location and the departure time associated with the appointment request needed to be distributed.

In some embodiments, the service involved may include an online to offline vehicle service. Taking the online to offline vehicle service as an example, the online to offline vehicle service may include a plurality of different types. For example, an express service, a premier car service, a shuttle service, a testing drive service and car hailing service. Wherein, some types of vehicle services may support an advance reservation, which may allow service requester terminal to issue request in advance. Therefore, the appointment request needed to be distributed may be an appointment request issued in advance by the service requester terminal for the online to offline vehicle service.

In some embodiments, departure location and the departure time associated with the appointment request may be obtained according to the request content of the appointment request needed to be distributed.

In 8202, the server 110 or the server 2104 may determine the target time of the appointment request according to the departure location and the departure time.

In this embodiment, the target time of the appointment request may be determined according to the departure location and the departure time associated with the appointment request needed to be distributed. The target time may be a reasonable time to distribute the appointment request.

In an implementation manner of this embodiment, statistical analysis may be performed on the historical data. Thereby, the distribution rule of the transport capacity in time and space may be obtained, and the optimal time to distribute the appointment request may be estimated as the target time according to the distribution rule and the departure time.

In another implementation manner of this embodiment, a machine learning method may also be used to determine the target time to distribute the appointment request. Specifically, a pre-trained trained model may be obtained, and the optimal time to distribute the appointment request may be predicted as the target time by using the trained model according to the departure location and the departure time associated with the appointment request.

It should be understood that the target time of the appointment request may be determined according to the departure location and the departure time by other means, and the disclosure is not limited in this aspect.

In 8203, the appointment request may be distributed in response to the arrival of the target time.

In this embodiment, when the target time arrives, the appointment request may be distributed. For example, the processing device 112 may broadcast the appointment request at the target time, or match an appropriate service provider for the appointment request at the target time. It should be understood that the present disclosure may not limit the manners to distribute the appointment request.

The method for distributing the appointment request provided by the embodiments of the present disclosure may determine the target time to distribute the appointment request according to the departure location and the departure time by determining the departure location and the departure time associated with the appointment request of the distribution, and distribute the appointment request in response to the arrival of the target time. Therefore, the appointment request may be distributed at a reasonable time, which may avoid the problem that the service provider may wait too long after accepting the order, or the request may be not successfully matched with a service provider until the order departure time, and improve service efficiency and utilization of service resources.

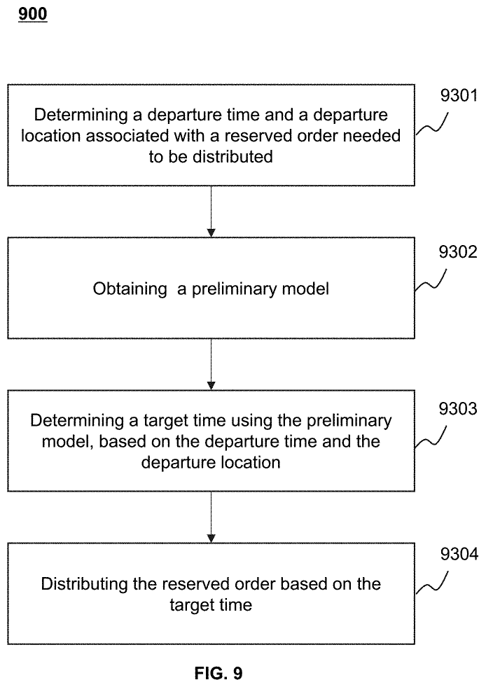

FIG. 9 is a flowchart illustrating another method for distributing an appointment request according to some embodiments of the present disclosure. The method may be executed by a server. The method may include following operations:

In 9301, the server 2104 or 110 may determine the departure location and the departure time associated with the appointment request needed to be distributed.

In 9302, a pre-trained model may be obtained.

In 9303, the target time may be determined using the pre-trained model according to the departure location and the departure time.

In some embodiments, the trained model may include any of the following: a logistic regression model, a decision tree model, a neural network model.

In some embodiments, the target time may be determined using the trained model according to the departure location and the departure time as follows: Firstly, the target information may be obtained according to the departure location and the departure time. Then, the target features may be extracted from the target information, and the target features may be input into the trained model, and the target time may be obtained from the output of the trained model.

In 9304, the appointment request may be distributed in response to the arrival of the target time.

It should be noted that, some operations in FIG. 3 which may be same some operations in FIG. 2, and not repeated again in FIG. 3, and more detailed description may be referred to FIG. 2 and the description thereof.

The method for distributing the appointment request provided by the embodiments of the present disclosure may determine the target time to distribute the appointment request according to the departure location and the departure time by determining the departure location and the departure time associated with the appointment request of the distribution, and distribute the appointment request in response to the arrival of the target time. Therefore, the appointment request may be distributed at a reasonable time, which may avoid the problem that the service provider may wait too long after accepting the order, or the request may be not successfully matched with a service provider until the order departure time, and improve service efficiency and utilization of service resources.

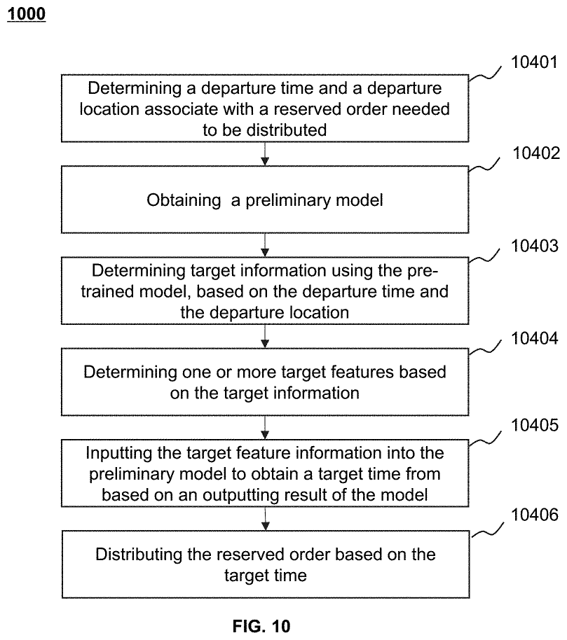

FIG. 10 is a flowchart illustrating another method for distributing an appointment request according to some embodiments of the present disclosure. The method may be executed by a server. The method may include following operations:

In 10401, the server 2104 or 110 may determine the departure location and the departure time associated with the appointment request needed to be distributed.

In 10402, a pre-trained model may be obtained.

In some embodiments, the model may be trained as follows: Firstly, the server 2104 or 110 may obtain the sample information of the request sample data set. The sample information may include a month-on-previous-month reference information associated with the departure location of the request sample, a year-on-year reference information, and a real-time reference information.

Then, the sample feature information may be obtained based on the sample information, and a distribution time information of the sample request may be obtained based on the sample information. The sample feature information may include a sample month-on-previous-month feature information, a sample year-on-previous-year feature information, and a sample real-time feature information. The sample month-on-previous-month feature information may include but is not limited to feature information about total amount of requests, feature information about the transport capacity, feature information about the response rate, feature information about the response time, feature information about dynamic fee adjustment, and the like, in a server region associated with the departure location of the sample request in a sample month-on-previous-month time period.

The sample year-on-previous-year feature information may include but is not limited to feature information total about amount of requests, feature information about the transport capacity, feature information about the response rate, feature information about the response time, feature information about dynamic fee adjustment, and the like, in a server region associated with the departure location of the sample request in a sample year-on-year time period.

The sample real-time feature information may include but is not limited to feature information total about amount of requests, feature information about the transport capacity, feature information about the response rate, feature information about the response time, feature information about dynamic fee adjustment, and the like, in a server region associated with the departure location of the sample request in a real-time time period.

Finally, the model may be trained using the sample feature information and the distribution time of the sample request to obtain the trained model.

In 10403, target information may be obtained according to the departure location and the departure time.

In some embodiments, specifically, the server region associated with the departure location may be determined firstly. The server region associated with the department location may be a region of a preset area around the department location. For example, the service may be a circle region whose preset distance is a radius and the departure location may be the center of the circle. It should be understood that the present disclosure may not limit the server region associated with the department location.

Then, the month-on-previous-month time period, the year-on-previous-year time period, and the real time period associated with the departure time may be determined. And reference information associated with the server region in a month-on-previous-month time period, the year-on-previous-year time period, and the real-time time period may be obtained, and based on the reference information, the target information may be obtained. The reference information associated with the server region may include, but is not limited to, a total amount of orders information, a transport capacity information, a response rate information, a response time information, a dynamic fee adjustment information, and the like, or any combination thereof.

In 10404, the target features may be extracted from the target information.

In some embodiments, the target features may include: month-on-previous-month feature information, year-on-previous-year feature information, and real time feature information. In some embodiments, the month-on-previous-month feature information may include one or more of the following: feature information about total amount of requests in the server region during the month-on-previous-month time period; feature information about transport capacity in the server region during the month-on-previous-month time period; feature information about response rate feature information in the server region during a month-on-previous-month time period; feature information about response time in the server region during the month-on-previous-month time period; feature information about dynamic fee adjustment in the server region during the month-on-previous-month time period.

The feature information during the year-on-previous-year time period may include one or more of the followings: the feature information about total amount of requests in the server region during the year-on-previous-year time period; feature information about the transport capacity in the server region during the year-on-previous-year time period; feature information about the response rate in the server region during the year-on-previous-year time period; feature information about the response time in the server region during the year-on-previous-year time period; feature information about the dynamic fee adjustment in the server region during the year-on-previous-year time period.

The real-time feature information may include one or more of the followings: the feature information about total amount of requests in the server region during real-time time period; feature information about the transport capacity in the server region during the real-time time period; feature information about the response rate in the server region during the real-time time period; feature information about the response time in the server region during the real-time time period; feature information about the dynamic fee adjustment in the server region during the real-time time period.

In 10405, the target features may be inputted into the trained model to obtain target time from output results of the trained model.

In 10406, the appointment request may be distributed in response to the arrival of the target time.

It should be noted that the same operations in the FIG. 2 and FIG. 3 embodiments are not described again in embodiments of FIG. 4, and the related content may be referred to the embodiments in FIG. 2 and FIG. 3.

The method for distributing the appointment request provided by the embodiments of the present disclosure may determine the target time to distribute the appointment request according to the departure location and the departure time by determining the departure location and the departure time associated with the appointment request of the distribution, and distribute the appointment request in response to the arrival of the target time. Therefore, the appointment request may be distributed at a reasonable time, which may avoid the problem that the service provider may wait too long after accepting the order, or the request may be not successfully matched with a service provider until the order departure time, and improve service efficiency and utilization of service resources.

It should be noted that, while operations of the disclosed method are described in the drawings in a particular order, this does not require or imply that these operations must be performed in that particular order, or that all illustrated operations be performed to achieve desirable results. On the contrary, the execution orders of the steps depicted in the flowcharts can be changed. Additionally or alternatively, certain operations may be omitted, combined into one and/or divided into a plurality of operations.

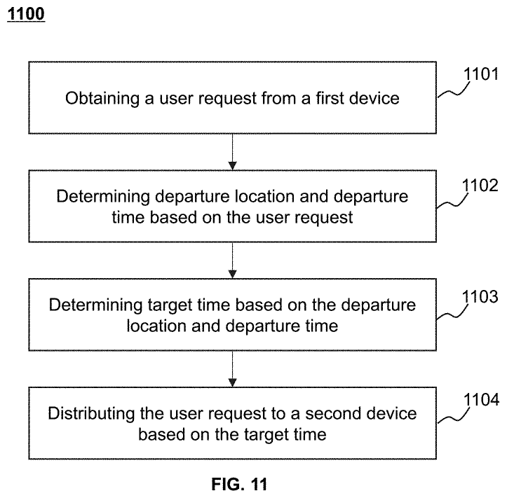

FIG. 11 is a flowchart illustrating a process 1100 for distributing a user request according to some embodiments of the present disclosure. In some embodiments, the process 1100 shown in FIG. 11 may be implemented in the online to offline service system 100 illustrated in FIG. 1. For example, the process 1100 may be implemented as a set of instructions stored in the storage ROM 230 or RAM 240. The processor 320 and/or the modules in FIG. 7 may execute the set of instructions, and when executing the instructions, the processor 320 and/or the modules may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process 1100 illustrated in FIG. 11 and described below is not intended to be limiting.

In 1101, the processing device 112 (e.g., the obtaining module 710) may obtain a user request from a first device.

In some embodiments, the user request (also refered as current user reques) may be used to request an online to offline service for the user. The online to offline service may include a a delivery service, a taxi-hailing service, a test drive service, a designated driving service, or the like, or any combination thereof. In some embodiments, the user request may include a real-time request, an appointment request, or a pending request, or the like. In some embodiments, the user request may be generated by the processing device 112 based on request information from the first device. The first device may be used to communicate and/or connect the user with and/or to the online to offline system 100 via the network 120 or network 2103. For example, the user may input the travel information into the first device through the I/O 350.

Taking the taxi-hailing service as an example, the request information may include information about the request, information about the user, and other information. The information about the request may include but not limited to a time point when the request may be sent, an request identification, a departure location, a destination, a departure time, an arrival time, an acceptable waiting time, the number of passengers, whether agrees to share a vehicle with other passengers, a selected vehicle model, carrying luggage or not, a mileage, a price, an increasing price by consumer, a price adjustment by the service provider, a price adjustment by the system, a status of using red packet, a payment mode (e.g., a cash payment, a credit card payment, an online payment, a remittance payment), request completion status, request selection status by the service provider, request sending status by the consumer, or the like, or any combination thereof. The information about the user may include but not limited to name, nickname, gender, nationality, age, contact information (phone number, microphone number, social network account (e.g., WeChat number, QQ number, LinkedIn account, etc.), or the like, or other way through which a person can be contacted), occupation, grade evaluation, driving experience, vehicle age, vehicle type, vehicle status, vehicle license number, driving license number, authentication status, user preference, extra service (e.g., extra service including a size of the vehicle trunk, a panoramic sunroof), or the like, or any combination thereof. The other information may include information that is not controlled by the consumer or the service provider or temporal/emergent information. For example, the other information may include but not limited to weather status, environment, road (e.g., blocked road because of safety or road works), traffic, or the like, or any combination thereof.

In some embodiments, the first device may include one or more terminals (e.g., the service requestor terminal 130). In some embodiments, the first device may send the user request to the processing device 112 via a data exchange port that is communicatively connected to the network 120. The processing device 112 may obtian the user request via the data exchange port.

In 1102, the processing device 112 (e.g., the determining module 720) may determine departure location and departure time based on the user request.

In some embodiments, the processing device 112 may process the travel information of the user and determine the departure location and departure time based on the user's travel information inputted by the user. In some embodiments, the processing engine 112 may determine current location information of the user via a positioning device on the first device (e.g., the service requester terminal 130) as the departure location. In some embodiments, the processing device 112 may determine the time that the first device sent the user request as the departure time. For example, the departure location may be obtained by one or more positioning chips installed in the first device and/or a navigation system (not shown in figures). As another example, the departure location may be determined by the processing engine 112 based on user preference, historical requests and/or information (e.g., historical orders), etc. As a further example, the processing engine 112 may recommend a departure location to the user based on historical requests launched by the user.

In 1103, the processing device 112 (e.g., the determining module 1103) may determine target time based on the departure location and departure time.

In some embodiments, the target time may be a preference time for the online to the offline system 100 to distribute the user request to another device (e.g., a second device). For example, the target time may be a time point at which the distributed request may have a higher successful turnover rate. As another example, the target time may be a time period during which the cost of the request may be lower than during other time periods. For example, the target time may be a time period from 20 minutes to 90 minutes before the starting time of the service. The processor 320 may distribute the appointment invitation to a plurality of service provider terminals before 20 minutes to 90 minutes of the departure time.

In some embodiments, the processing device 112 may determine the target time based on a plurality of historical requests launched by one or more users. The historical request may include but not limited to request information The plurality of historical requests may include the requests have a time interval from the current time, for example, 5 minutes, one hour, one day, one month, one year, etc. The time interval may be preset by the online to offline system 100 or may be adjusted according to different conditions. The plurality of historical requests may be stored in a storage device, e.g., the storage device 150. In some embodiments, the processing device 112 may communicate with or connected to the storage device to obtain all of or part of the historical requests via the network 120, e.g., the departure location, the departure time, the distributing time, an equation between the departure location, departure time and the distributing time, or the like, or any combination thereof. For example, the processing device 112 may determine a distributing time of a historical request who may have same or similar departure location and departure time as or with the user request from the first device as the target time of the user request. As another example, the processing device 112 may determine the target time of the user request using a fitting method and/or an interpolation method based on the equation between the departure location, departure time and the distributing time. As still another example, the processing device 112 may determine the target time of the user request using a prediction model. The prediction model may include but is not limited to a weighted arithmetic average model, a trend average prediction model, an exponential smoothing model, an average development speed model, a unitary linear regression model, and a high and low point model. As a further example, the processing device 112 may determine the target time of the user request using a model training method. The model may include but is not limited to a regression algorithm model, an instance-based model, a normalized model, a decision tree model, a Bayesian model, a clustering algorithm model, an association rule model, a neural network model, a deep learning model, a reduced dimensional algorithm model, etc. More detailed description for model training method may be found elsewhere in the present disclosure, for example, FIG. 14 and the description thereof.

In 1104, the processing device 112 (e.g., the distributing module 740) may distribute the user request to a second device based on the target time.

In some embodiments, the processing device 112 may transmit information (e.g., the request information) to one or more service provider terminals 140, one or more service request terminals 130, one or more third parties, or the like, or any combination thereof.

In some embodiments, the second device may include one or more terminals (e.g., the service provider terminal 140). In some embodiments, the first device may send/receive information or signal to/from the processing device 112 via a data exchange port that is communicatively connected to the network 120. The processing device 112 may distribute the user request to the second device via the data exchange port. In some embodiments, the processing device 112 may distribute the user request to one or more service provider terminals 140. The one or more service provider terminals 140 may grab the request. In some embodiments, the processing engine 112 may distribute the request to one service provider terminal of the one or more service provider terminals. For example, the processing device 112 may rank the one or more select one service provider terminals according to a preset rule, and select the top one service provider and distribute the request to the service provider terminal. In some embodiments, a form of the distributed request may include but is not limited to texture, picture, audio, video, or the like, or any combination thereof.

In some embodiments, the processing device 112 may transmit the signals according to any suitable communication protocol. The suitable communication protocol may include but not limited to Hypertext Transfer Protocol (HTTP), Address Resolution Protocol (ARP), Dynamic Host Configuration Protocol (DHCP), File Transfer Protocol (FTP), etc. It should be noted that the signal may include any wired signal and/or wireless signal.

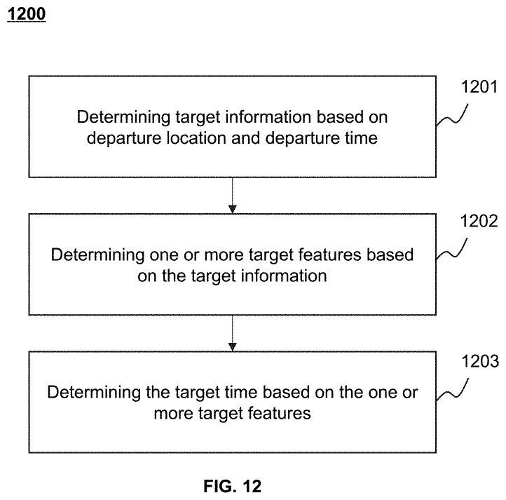

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations illustrated in FIG. 12 may be added in process 1100. In some embodiments, one or more operations may be added elsewhere in the process 1100. For example, a display operation may be added after operation 1104.

FIG. 12 is a flowchart illustrating a process 1200 for determining a target time according to some embodiments of the present disclosure. In some embodiments, the process 1200 shown in FIG. 12 may be implemented in the online to offline service system 100 illustrated in FIG. 1. For example, the process 1200 may be implemented as a set of instructions stored in the storage ROM 230 or RAM 240. The processor 320 and/or the modules in FIG. 7 may execute the set of instructions, and when executing the instructions, the processor 320 and/or the modules may be configured to perform the process 1200. The operations of the illustrated process presented below are intended to be illustrative. In some embodiments, the process 1200 may be accomplished with one or more additional operations not described and/or without one or more of the operations discussed. Additionally, the order in which the operations of the process 1200 illustrated in FIG. 12 and described below is not intended to be limiting.

In 1201, the processing device 112 (e.g., the determining module 720) may determine target information based on departure location and departure time.

In some embodiments, the target information may indicate information of a plurality of service requests associated with the departure location and the departure time. In some embodiments, the target information may include all or portion of the user request information. For example, the target information may include the number or amount of the requests, the number or amount of the second devices, the traffic condition, the requests turnover condition, user's feedback, or the like, or any combination thereof. In some embodiments, the target information may be stored on a storage device (e.g., the storage device 150), the processing may obtain the target information from the storage device directly or via the network 120.

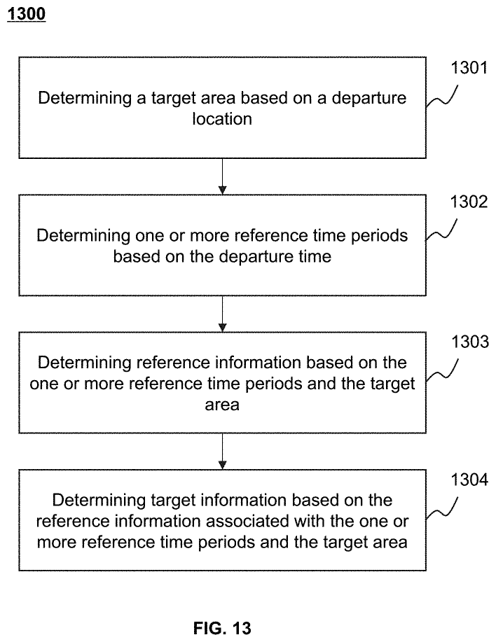

The processing device 112 may determine the target information within a target area associated with the departure location and a target time period associated with the departure time. In some embodiments, the target area may include an area which the departure location may be in. In some embodiments, the time period may be associated with the departure time. The time period may include a historical time period, a current time period, etc. More detailed description for determining the target information may be found elsewhere in the present disclosure, for example, FIG. 13 and the description thereof.

In 1202, the processing device 112 (e.g., the determining module 720) may determine one or more target features based on the target information.

The one or more target features may include the features to identify the service request. In some embodiments, the target features may include all of or a portion of the target information. In some embodiments, the target features may include target features associated with the historical requests and/or target features associated with the current service request. For example, the target features may include at least one of amount of the user request associated with the target area, amount of the second device associated with the target area, a response rate associated with the user request in the target area, or a response time associated with the user request in the target area. In some embodiments, the processing device 112 may determine the one or more target features by processing the target information. The processing method of the target information may include but is not limited to a filtering method, a matching method, or a model training method, or the like, or any combination thereof. In some embodiments, the processing device 112 may select one or more target features from the plurality of features based on the weights of the features. For example, the processing device 112 may select feature(s) with top N weights as the target feature(s). N may be any positive value (e.g., 10, 20, and 30) or percentage (e.g., 10%, 20%, and 30%).

In 1203, the processing device 112 may determine the target time based on the one or more target features.

In some embodiments, the target time may be a time point at which the service request may be distributed to a second device (e.g., the service provider terminal 140). In some embodiments, the processing device 112 may determine the target time based on one or more service requests which may have same or similar target features with the current service request in an area (e.g., the target area, other area, etc.). For example, the processing device 112 may obtain the one or more service requests which may same or similar target features with the current service request. And, the processing device 112 may process the one or more service requests, for example, ranking the one or more service requests according to a preset rule (e.g., a similarity degree between the target features of the one or more requests and the current service request). In some embodiments, the processing device 112 may determine a distributing time of one of one or more service requests (e.g., the top one service request) as the target time of the current service. In some embodiments, the processing device 112 may determine an average of the distributing time of the one or more service requests (e.g., the top 5 service requests, the top 10 service requests, all the service request, etc.) as the target time of the current service request.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations illustrated in FIG. 13 may be added in process 1200. In some embodiments, one or more operations may be added elsewhere in the process 1200. For example, a storage operation may be added after operation 1201, 1202 and 1203.

FIG. 13 is a flowchart illustrating a process 1300 for determining a target information according to some embodiments of the present disclosure. In some embodiments, the process 1300 shown in FIG. 13 may be implemented in the online to offline service system 100 illustrated in FIG. 1. For example, the process 1300 may be implemented as a set of instructions stored in the storage ROM 230 or RAM 240. The processor 320 and/or the modules in FIG. 7 may execute the set of instructions, and when executing the instructions, the processor 320 and/or the modules may be configured to perform the process 1300. The operations of the illustrated process presented below are intended to be illustrative. In some embodiments, the process 1300 may be accomplished with one or more additional operations not described and/or without one or more of the operations discussed. Additionally, the order in which the operations of the process 1300 illustrated in FIG. 13 and described below is not intended to be limiting.

In 1301, the processing device 112 (e.g., the determining module 720) may determine a target area based on a departure location.

In some embodiments, the target area may be a service area including the departure location. For example, the service area may be the area within a distance from the departure location. Merely for an example, the service area may be an area within a certain radius (50 m, 100 m, 1000 m) from the departure location, wherein the certain radius may be pre-determined or adjusted according to different conditions manually, automatically, or a combination thereof. As another example, the service area may be a district including the departure location. As still another example, the service area may be a city including the departure location. Merely for illustration purpose, the departure location may be the Peking University, the target area may be determined by the processing device 112 as the area of the Peking University school, the Haidian district, the city of Beijing, or the like.

In 1302, the processing device 112 (e.g., the determining module 720) may determine one or more reference time periods based on the departure time.

The one or more reference time periods may include a historical time period. For example, the time period may include a month-on-previous-month time period, a year-on-previous-year time period, etc. Merely for example, the reference time period may be a time interval (e.g., 5 minutes, 10 minutes, 1 hour, 10 hours, 1 day, 2 days, 5 days, 10 days, one month) before a current time (e.g., a request sending time). In some embodiments, the reference time period may be predetermined manually or may be determined automatically by the online to offline service system 100.

In 1303, the processing device 112 (e.g., the determining module 720) may determine reference information based on the one or more reference time periods and the target area.

In some embodiments, the reference information may include the request information and other information associated with the departure location and the departure. Specifically, the reference information may include the request information and other information in the target area within the one or more reference time periods. For example, the reference information may include the service providers information in the target area within the one or more reference time periods. As another example, the reference information may include service request information of the service requests in the target area within the one or more reference time periods. As further example, the reference information may include other information (e.g., a traffic condition, a weather condition, etc.) in the target area within the one or more target time periods. More detailed description about the request information and other information may be found elsewhere in the present disclosure, for example, operation 1101 in FIG. 11.

In 1304, the processing device 112 (e.g., the determining module 720) may determine target information associated with the one or more reference time periods and the target area.

The target information may include all of a portion of the reference information and/or processed reference information. The target information may be determined based on the reference information. In some embodiments, the processing device 112 may process the one or more reference information and determine the target information. Processing of the reference information may include but not limited to storing, classifying, filtering, converting, calculating, retrieving, predicting, training, or the like, or any combination thereof. For example, the processing device 112 may determine the amount of the user requests based on the reference information by summing all the service requests associated with the one or more reference time periods and the target area. As another example, the processing device 112 may determine an average time of distributing service requests associated with the one or more reference time periods and the target area based on the distributing time of each of the service requests associated with the one or more reference time periods and the target area. In some embodiments, the target information may be stored in a storage device (e.g., the storage device 150). The processing device may obtain the target information from the storage device directly or via the network 120 for other process (e.g., the process 1200).

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 14 is a flowchart illustrating a process 1400 for determining a target information based on a trained model according to some embodiments of the present disclosure. In some embodiments, the process 1400 shown in FIG. 14 may be implemented in the online to offline service system 100 illustrated in FIG. 1. For example, the process 1400 may be implemented as a set of instructions stored in the storage ROM 230 or RAM 240. The processor 320 and/or the modules in FIG. 7 may execute the set of instructions, and when executing the instructions, the processor 320 and/or the modules may be configured to perform the process 1400. The operations of the illustrated process presented below are intended to be illustrative. In some embodiments, the process 1400 may be accomplished with one or more additional operations not described and/or without one or more of the operations discussed. Additionally, the order in which the operations of the process 1400 illustrated in FIG. 14 and described below is not intended to be limiting. In some embodiments, the training model process may be an online.

In 1401, the processing device 112 (e.g., the obtaining module 710) may obtain a preliminary model.

In some embodiments, the preliminary model may be an initial model to be trained to obtain a trained model using a plurality of training samples. In some embodiments, the preliminary model may include a preliminary logistic regression model, a preliminary adaptive boosting model or a preliminary gradient boosting decision tree (GBDT) model, etc. In some embodiments, the preliminary model may have default settings (e.g., one or more preliminary parameters) of the online to offline service system 100 or be adjustable in different situations. Taking a preliminary model of GBDT model as an example, the preliminary GBDT model may include one or more preliminary parameters, such as a booster type (e.g., tree-based model or linear model), a booster parameter (e.g., a maximum depth, a maximum number of leaf nodes), a learning task parameter (e.g., an objective function of training), or the like, or any combination thereof.

In 1402, the processing device 112 (e.g., the obtaining module 710) may obtain a plurality of training samples using the obtained plurality of training samples.

In some embodiments, the plurality of the training samples may be obtained from a plurality of historical service requests. For example, the plurality of the training samples may be obtained based on the departure location and the departure time associated with a current user service request. In some embodiments, the plurality of training sample may include the plurality of historical service requests which may have similar or same target features to or with the current service request in the target area associated with the departure location or other area within a target period time. The plurality of training samples may be stored in a storage device (e.g., the storage device 150). The processing device 112 may obtain the plurality of training sample from the storage device directly or via the network 120. More detailed description of obtaining the one or more target features may be found elsewhere in the present disclosure, for example, FIG. 12 and the description thereof.

The processing device 112 may input the target features of each of the plurality of historical service requests into the preliminary model to output a corresponding target time. The processing device 112 may further determine a difference between the outputted target time and a known target time of the plurality of historical service requests. The difference may also be referred to as a loss function for brevity. According to the loss function, the processing device 112 may further adjust the preliminary model (e.g., adjust the preliminary parameters) until the loss function reaches a desired value. After the loss function reaches the desired value, the adjusted preliminary model may be designated as the trained model.

In 1404, the processing device 112 (e.g., the determining module 720) may determine the target time based on the trained model.

In some embodiments, the processing device 112 may obtain a user request from the first device. Based on the user request, the processing device 112 may determine departure location and departure time associated with the user request. And based on the departure location and departure time, the processing device 112 may determine target information, and determine one or more target features based on the target information. In some embodiments, the target features may be transmitted to another process. In some embodiments, the target features may be stored in a storage device 150. More detailed description for determining the one or more target features may be found elsewhere, for example, FIG. 12, and the description thereof. In some embodiments, after obtaining the target features, the processing device 112 may input the target features into the trained model, and obtain the target time from the results outputted by the trained model.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added elsewhere in the process 1400. For example, an evaluating operation to evaluate the trained model (e.g., obtain accuracy rate and hit rate of the trained model) may be added after the operation 1403. As another example, process 1400 may further include storing the trained model after obtaining the trained model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system for distributing a user's request, comprising:
at least one storage medium storing a set of instructions;
at least one processor in communication with the at least one storage medium, when executing the stored set of instructions, the at least one processor causes the system to:
obtain a user request from a first device;
determine a departure location and a departure time based on the user request;
determine a target time based on the departure location and the departure time; and
distribute the user request to a second device based on the target time.

2. The system of claim 1, wherein the at least one processor is further configured to cause the system to:
obtain a trained model; and
determine the target time based on the trained model.

3. The system of claim 2, wherein the trained model is generated according to a process for training a model, the process comprising:
obtaining a preliminary model;
obtaining a plurality of training samples; and
training the preliminary model to obtain the trained model using the obtained plurality of training samples.

4. The system of claim 1, wherein to determine target time based on the departure location and departure time, the at least one processor is further configured to cause the system to:
determine target information based on the departure location and departure time;
determine one or more target features based on the target information; and
determine the target time based on the one or more target features.

5. The system of claim 4, wherein the at least one processor is further configured to cause the system to:
determine a target area based on the departure location;
determine one or more reference time periods based on the departure time;
determine reference information based on the one or more reference time periods and the target area; and
determine the target information based on the reference information associated with the one or more reference time periods and the target area.

6. The system of claim 4, wherein the one or more target features includes at least one of:
an amount of the user request associated with the target area,
an amount of second devices associated with the target area,
a response rate associated with the user request in the target area, or
a response time associated with the user request in the target area.

7. The system of claim 5, wherein the one or more reference time periods includes at least one of:
a month-on-previous-month time period corresponding to the departure time, or a year-on-previous-year time period corresponding to the departure time.

8. The system of claim 2, wherein the trained model includes a logistic regression model, an adaptive boosting model, or a gradient boosting decision tree (GBDT) model.

9. The system of claim 3, wherein the obtaining a plurality of training samples includes:
obtaining a historical order, wherein the historical order includes a historical departure time, a historical departure location and a historical distribution time;
determining historical information based on the historical departure location and historical departure time;
determining one or more sample features based on the historical information; and
determining a training sample based on the one or more sample features and the historical distribution time.

10. A method implemented on a computing device for distributing a user's request, the computing device including a memory and one or more processors, the method comprising:
obtaining a user request from a first device;
determining a departure location and a departure time based on the user request;
determining a target time based on the departure location and the departure time; and
distributing the user request to a second device based on the target time.

11. The method of claim 10, wherein the method further comprises:
obtaining a trained model; and
determining the target time based on the trained model.

12. The method of claim 11, wherein the trained model is generated according to a process for training a model, and the method further comprises:
obtaining a preliminary model;
obtaining a plurality of training samples; and
training the preliminary model to obtain the trained model using the obtained plurality of training samples.

13. The method of claim 10, wherein the determining the target time based on the departure location and the departure time further comprises:
determining target information based on the departure location and the departure time;
determining one or more target features based on the target information; and
determining the target time based on the one or more target features.

14. The method of claim 13, wherein the determining the target information based on the departure location and the departure time comprises:
determining a target area based on the departure location;
determining one or more reference time periods based on the departure time;
determining reference information based on the one or more reference time periods and the target area; and
determining the target information based on the reference information associated with the one or more reference time periods and the target area.

15-20. (canceled)

21. A method for distributing an appointment request, wherein the method comprises:
determining a departure location and a departure time associated with the appointment request needed to be distributed;
determining a target time of the appointment request based on the departure location and the departure time; and
distributing the appointment request in response to the arrival of the target time.

22. The method of claim 21, wherein the determining the target time of the appointment request based on the departure location and the departure time comprises:
obtaining a pre-trained model; and
determining the target time using the pre-trained model based on the departure location and the departure time.

23. The method of claim 22, wherein the determining the target time using the pre-trained model based on the departure location and the departure time comprises:
obtaining target information based on the departure location and the departure time;
extracting target features from the target information; and
inputting the target features into the pre-trained model to obtain the target time from output results of the pre-trained model.

24. The method of claim 23, wherein the obtaining target information based on the departure location and the departure time comprises:
determining a service region associated with the department location;
determining a month-on-previous-month time period, a year-on-previous-year time period, and a real-time time period corresponding to the departure time; and
obtaining, within the month-on-previous-month time period, the year-on-previous-year time period, and the real-time time period, reference information associated with the service region to obtain target feature information.

25. The method of claim 24, wherein the target feature information comprises: month-on-previous-month feature information, year-on-previous-year feature information, and real time feature information.

26. The method of claim 25, wherein the year-on-previous-year feature information comprises at least one of:
feature information associated with a total amount of requests in the service region during the year-on-previous-year period;
feature information associated with a transport capacity in the service region during the year-on-previous-year period;
feature information associated with a response rate in the service region during the year-on-previous-year time period;
feature information associated with a response time in the service region during the year-on-previous-year time period; or
feature information associated with dynamic fee adjustment in the service region during the year-on-previous-year time period;
the month-on-previous-month feature information comprises at least one of:
feature information associated with a total amount of requests in the service region during the month-on-previous-month time period;
feature information associated with a transport capacity in the service region during the month-on-previous-month time period;
feature information associated with a response rate in the service region during the month-on-previous-month time period;
feature information associated with a response time in the service region during the month-on-previous-month time period;
feature information associated with dynamic fee adjustment in the service region during the month-on-previous-month time period; or
the real-time feature information comprises at least one of:
feature information associated with a total amount of requests in the service region during the real-time time period;
feature information associated with a transport capacity in the service region during the real-time preset time period;
feature information associated with a response rate in the service region during the real-time time period;
feature information associated with response time in the service region during the real-time preset time period; or
feature information associated with dynamic fee adjustment in the service region during the real-time time period.

27-34. (canceled)
